(19) United States
(12) Patent Application Publication
(10) Pub. No.: US 2026/0270863 A1
(43) Pub. Date: Sep. 10, 2026

(54) ENERGY AWARE COMMUNICATION IDENTIFICATION IN TELECOMMUNICATIONS NETWORK

(71) Applicant: Telefonaktiebolaget LM Ericsson (publ), Stockholm (SE)

(72) Inventors: Konstantinos VANDIKAS, Solna (SE); Aneta VULGARAKIS FELJAN, Stockholm (SE); Anusha Pradeep MUJUMDAR, Bangalore (IN); Marin ORLIC, Bromma (SE)

(21) Appl. No.: 18/034,333

(22) PCT Filed: Oct. 29, 2020
(86) PCT No.: PCT/EP2020/080423

§ 371 Date: Apr. 27, 2023

(51) Int. Cl. H04W 52/02; H04W 72/1263; H04W 72/50

(52) U.S. Cl. CPC H04W 52/0206; H04W 72/1263; H04W 72/50

(57) ABSTRACT

A method performed by a network node for a telecommunications network is provided. The method includes comparing a predicted energy consumption from a communication device based prediction model for each network node in a set of network nodes for an uplink or downlink communication with a communication device, with a predicted amount of energy available from a network node based prediction model. The method further includes determining whether the predicted amount of energy available is sufficient to provide at least a portion of the predicted energy consumption. The method further includes identifying one or more time periods, a length of each of the one or more time periods, and a corresponding network node for each of the time periods when the predicted amount of energy available is sufficient to provide at least a portion of the predicted energy consumption.

### TECHNICAL FIELD

The present disclosure relates generally to energy aware communication identification in a telecommunications network, and related methods and apparatuses.

### BACKGROUND

In some approaches for data centers, a process of scheduling tasks to execute may be performed in such a way that the tasks consume green energy, e.g. enough green energy has been stored, more energy is/or will be generated and as such has to be consumed since it cannot be stored. Thus, a balance may be struck between demand and supply for energy for data centers. See e.g., https://blog.google/inside-google/infrastructure/data-centers-work-jarder-sun-shines-wind-blows. Tasks (or workload) that typically take place in data centers are computational, meaning the tasks consume central processing unit (CPU) (or graphical processing unit (GPU)) memory and physical storage. Additional information around how to orchestrate the workload is made available by way of one or more data sources which describe an amount of resources needed (e.g., number of CPUs, memory, etc.).

### SUMMARY

In various embodiments, a method performed by a network node for a telecommunications network is provided. The method includes comparing, for each of a plurality of time periods, (1) a predicted energy consumption of each network node in a set of network nodes for an uplink or downlink communication with a communication device, wherein the predicted energy consumption is from a communication device based prediction model, with (2) a predicted amount of energy available from each network node in the set of network nodes, wherein the predicted amount of energy available is from a network node based prediction model. The method further includes determining, for each of the plurality of time periods, whether the predicted amount of energy available from each network node in the set of network nodes is sufficient to provide at least a portion of the predicted energy consumption. The method further includes identifying one or more time periods from the plurality of time periods, a length of each of the one or more time periods, and a corresponding network node from the set of network nodes for each of the one or more time periods when the predicted amount of energy available is sufficient to provide at least a portion of the predicted energy consumption.

In various embodiments, a network node for a telecommunications network is provided. The network node includes at least one processor, and at least one memory connected to the at least one processor and storing program code that is executed by the at least one processor to perform operations. The operations include compare, for each of a plurality of time periods, (1) a predicted energy consumption of each network node in a set of network nodes for an uplink or downlink communication with a communication device, wherein the predicted energy consumption is from a communication device based prediction model, with (2) a predicted amount of energy available from each network node in the set of network nodes, wherein the predicted amount of energy available is from a network node based prediction model. The operations further include determine, for each of the plurality of time periods, whether the predicted amount of energy available from each network node in the set of network nodes is sufficient to provide at least a portion of the predicted energy consumption. The operations further include identify one or more time periods from the plurality of time periods, a length of each of the one or more time periods, and a corresponding network node from the set of network nodes for each of the one or more time periods when the predicted amount of energy available is sufficient to provide at least a portion of the predicted energy consumption.

In various embodiments, a network node for a telecommunications network is provided. The network node is adapted to perform operations. The operations include compare, for each of a plurality of time periods, (1) a predicted energy consumption of each network node in a set of network nodes for an uplink or downlink communication with a communication device, wherein the predicted energy consumption is from a communication device based prediction model, with (2) a predicted amount of energy available from each network node in the set of network nodes, wherein the predicted amount of energy available is from a network node based prediction model. The operations further include determine, for each of the plurality of time periods, whether the predicted amount of energy available from each network node in the set of network nodes is sufficient to provide at least a portion of the predicted energy consumption. The operations further include identify one or more time periods from the plurality of time periods, a length of each of the one or more time periods, and a corresponding network node from the set of network nodes for each of the one or more time periods when the predicted amount of energy available is sufficient to provide at least a portion of the predicted energy consumption.

In various embodiments, a computer program including program code to be executed by processing circuitry of a network node is provided. The program code causes the network node to perform operations including compare, for each of a plurality of time periods, (1) a predicted energy consumption of each network node in a set of network nodes for an uplink or downlink communication with a communication device, wherein the predicted energy consumption is from a communication device based prediction model, with (2) a predicted amount of energy available from each network node in the set of network nodes, wherein the predicted amount of energy available is from a network node based prediction model. The operations further include determine, for each of the plurality of time periods, whether the predicted amount of energy available from each network node in the set of network nodes is sufficient to provide at least a portion of the predicted energy consumption. The operations further include identify one or more time periods from the plurality of time periods, a length of each of the one or more time periods, and a corresponding network node from the set of network nodes for each of the one or more time periods when the predicted amount of energy available is sufficient to provide at least a portion of the predicted energy consumption.

In various embodiments, a computer program product including a non-transitory storage medium including program code to be executed by processing circuitry of a network node is provided. Execution of the program code causes the network node to perform operations. The operations include compare, for each of a plurality of time periods, (1) a predicted energy consumption of each network node in a set of network nodes for an uplink or downlink communication with a communication device, wherein the predicted energy consumption is from a communication device based prediction model, with (2) a predicted amount of energy available from each network node in the set of network nodes, wherein the predicted amount of energy available is from a network node based prediction model. The operations further include determine, for each of the plurality of time periods, whether the predicted amount of energy available from each network node in the set of network nodes is sufficient to provide at least a portion of the predicted energy consumption. The operations further include identify one or more time periods from the plurality of time periods, a length of each of the one or more time periods, and a corresponding network node from the set of network nodes for each of the one or more time periods when the predicted amount of energy available is sufficient to provide at least a portion of the predicted energy consumption.

In various embodiments, a method performed by a communication device in a telecommunications network is provided. The method includes transmitting to a network node a predicted energy consumption of each network node in a set of network nodes for an uplink or downlink communication with the communication device, wherein the predicted energy consumption is from a communication device based prediction model. The method further includes, responsive to the transmitting, receiving a response from the network node comprising at least one of (1) a plurality of appointments between the communication device and another network node from the set of network nodes, wherein the plurality of appointments comprise an appointment for the uplink or downlink communication for the communication device with another network node from the set of network nodes, and (2) a message to continue communications with the network node.

In various embodiments, a communication device in a telecommunications network is provided. The communication device includes at least one processor, and at least one memory connected to the at least one processor and storing program code that is executed by the at least one processor to perform operations. The operations include transmit to a network node a predicted energy consumption of each network node in a set of network nodes for an uplink or downlink communication with the communication device, wherein the predicted energy consumption is from a communication device based prediction model. The operations further include receive a response from the network node comprising at least one of (1) a plurality of appointments between the communication device and another network node from the set of network nodes, wherein the plurality of appointments comprise an appointment for the uplink or downlink communication for the communication device with another network node from the set of network nodes, and (2) a message to continue communications with the network node.

In various embodiments, a communication device in a telecommunications network is provided. The communication device is adapted to perform operations. The operations include transmit to a network node a predicted energy consumption of each network node in a set of network nodes for an uplink or downlink communication with the communication device, wherein the predicted energy consumption is from a communication device based prediction model. The operations further include receive a response from the network node comprising at least one of (1) a plurality of appointments between the communication device and another network node from the set of network nodes, wherein the plurality of appointments comprise an appointment for the uplink or downlink communication for the communication device with another network node from the set of network nodes, and (2) a message to continue communications with the network node.

In various embodiments, a computer program including program code to be executed by processing circuitry of a communication device is provided. The program code causes the communication device to perform operations including transmit to a network node a predicted energy consumption of each network node in a set of network nodes for an uplink or downlink communication with the communication device, wherein the predicted energy consumption is from a communication device based prediction model. The operations further include receive a response from the network node comprising at least one of (1) a plurality of appointments between the communication device and another network node from the set of network nodes, wherein the plurality of appointments comprise an appointment for the uplink or downlink communication for the communication device with another network node from the set of network nodes, and (2) a message to continue communications with the network node.

In various embodiments, a computer program product including a non-transitory storage medium including program code to be executed by processing circuitry of a communication device is provided. Execution of the program code causes the communication device to perform operations. The operations include transmit to a network node a predicted energy consumption of each network node in a set of network nodes for an uplink or downlink communication with the communication device, wherein the predicted energy consumption is from a communication device based prediction model. The operations further include receive a response from the network node comprising at least one of (1) a plurality of appointments between the communication device and another network node from the set of network nodes, wherein the plurality of appointments comprise an appointment for the uplink or downlink communication for the communication device with another network node from the set of network nodes, and (2) a message to continue communications with the network node.

Tasks in different network nodes and communication devices in a telecommunications network may be very different in nature. As a consequence, identifying and scheduling energy aware communications in a telecommunications network is difficult. Potential advantages of disclosed embodiments may include enabling a network node to predict the demand for energy for tasks and as such power (including, without limitation, green energy) needed to accommodate or defer a task(s) that is not critical to take place to a different point in time when the needed power is available.

### BRIEF DESCRIPTION OF DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a telecommunications network;

FIG. 2 is a signal flow diagram illustrating an example of a process using traffic models from multiple UEs to generate a combined communication device based prediction model in accordance with some embodiments;

FIG. 3 is a simplified diagram of sequences from 3GPP TS 24.301 V13.8.0 (2016 September) illustrating a request that is submitted from a UE;

FIG. 4 is a sequence diagram illustrating operations of an attach process in accordance with some embodiments of the present disclosure;

FIG. 5 includes four bar charts illustrating energy harvesting for four base stations in accordance with some embodiments of the present disclosure;

FIG. 6 is a bar chart illustrating expected energy needed to handle a UE's data transmission at different time slots in accordance with some embodiments of the present disclosure;

FIG. 7 is an overlay bar chart illustrating a visual comparison of expected energy use from FIG. 6 with harvested energy from FIG. 5 in accordance with some embodiments of the present disclosure;

FIG. 8 is a block diagram illustrating a communication device (e.g., a UE) in accordance with some embodiments of the present disclosure;

FIG. 9 is a block diagram illustrating a network node (e.g., a base station eNB) in accordance with some embodiments of the present disclosure;

FIG. 10 is a block diagram illustrating a core network node (e.g., a serving gateway (SGW)) in accordance with some embodiments of the present disclosure;

FIGS. 11-12 are flow charts illustrating operations of a network node in accordance with some embodiments of the present disclosure; and

FIG. 13 is a flow chart illustrating operations of a communication device in accordance with some embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter. The term “communication device” is used in a non-limiting manner and, as explained below, can refer to any type of user equipment (UE). The terms “user equipment”, “UE”, and/or “user” herein may be interchangeable and replaced with the term “communication device”. Further, the term “network node” is used in a non-limiting manner and, as explained below, can refer without limitation to any type of network node in a telecommunications network including, without limitation, an eNB.

The following explanation of potential problems with some approaches is a present realization as part of the present disclosure and is not to be construed as previously known by others.

Data center approaches cannot be transferred directly to radio sites and cell equipment since tasks in radio sites are very different in nature. For example, a cell (which may be referred to as a radio network node in a 5th generation (5G) network) in a telecommunications network is typically tasked to perform the following exemplary operations. Communication device (e.g., a user equipment (UE)) related tasks include, without limitation (1) allocate resources for a UE so that afterwards the UE can start transferring traffic. Resources in this context include cells, wide beams, narrow beams, and carriers and the resources are not known in advance; (2) transfer traffic, and the amount of traffic is not known in advance; and (3) handover traffic, e.g., when a UE moves from one cell to another cell, the UE's traffic is redirected there. Management/Maintenance related tasks include, without limitation, remote electrical tilt, e.g., tilt an antenna to increase coverage and/or avoid interference, etc.

Various embodiments of the present disclosure may provide solutions to these and other potential problems. In various embodiments of the present disclosure, a method is provided that enables a site (e.g., a network node) to predict the demand for energy for tasks and, as a consequence, reserve needed power (green or otherwise) to accommodate or defer tasks that are not critical to take place at a different point in time where such power is available. While various embodiments are described with reference to a task of deferring data transmission between a UE and a network node (e.g., an eNodeB (eNB)) in such a way that utilizes as much as possible any renewable energy that has been collected by the network node or by nearby network nodes, the invention is not so limited. Instead, other tasks may be included, including without limitation, any of the tasks discussed herein. Energy may be collected (also referred to herein as “harvested”) by a network node from the surrounding environment such as from solar, wind, thermal, wireless (RF) based charging sources, etc. An energy harvesting model(s) at a network node can be used to produce electrical energy from the harvested sources for use in the telecommunications network (e.g., at the network node or a UE(s)). The network node can use one or more energy harvesting models, where each energy harvesting model corresponds to a different energy source, including the energy sources from the surrounding environment and from an electrical grid.

Potential advantages provided by various embodiments of the present disclosure may include better utilization of energy harvested by green sources thus relaxing the need to store such energy.

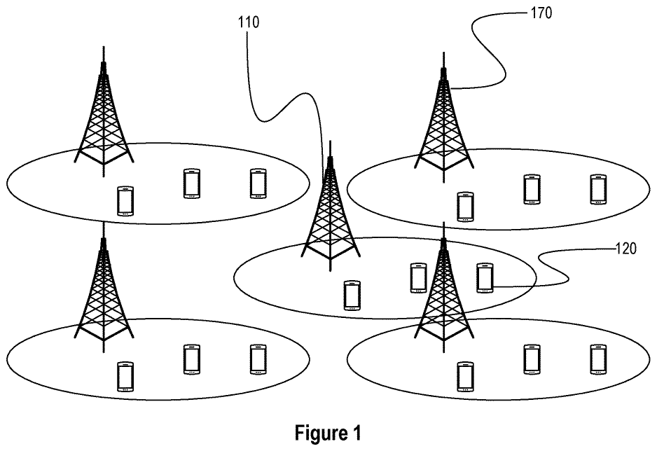

FIG. 1 illustrates an example of a long-term evolution (“LTE” or “4G”) telecommunications network including an evolved nodeB (“eNodeB” or “eNB”) 110, UEs 120, and neighboring eNBs 170. In some embodiments, the eNB 110 is able to predict the demand for energy for tasks (e.g., UE related tasks or management/maintenance related tasks) and, as such, reserve needed power (green or otherwise) to schedule such tasks immediately or defer tasks that are not critical to take place at a different point in time when such power is available.

Although FIG. 1 depicts an LTE or 4G telecommunications network, some embodiments described herein are not limited to LTE or 4G radio network nodes and can be applied to newer generations such new radio (“NR”) or 5^{th} generation (“5G”) networks and radio network nodes.

In an exemplary embodiment, the method provides for allocating (e.g., scheduling) resources for a UE to a network node (e.g., a radio base station (RBS)) that can support the UE's operation using green energy. The method includes inputting, or using, an energy consumption fingerprint and an energy production fingerprint. An “energy consumption fingerprint” refers to a communication device based prediction model that learns, e.g., how much energy each UE needs from a base station at different points in time. An “energy production fingerprint” refers to a network node based prediction model that learns, e.g., how much energy a network node (e.g., a base station) produces at different points in time.

In some embodiments, a training process for energy consumption is provided. For UEs, the method includes a communication device based prediction model. Performance of the communication device based prediction model includes two operations (1) training the model(s) for uplink and for downlink traffic for a UE; and (2) converting that to energy consumed by a base station (e.g., a network node).

In some embodiments, the training of the communication device based prediction model can be done either in a centralized or in a federated way. Additionally, because it may not be known whether each device (e.g., UE) has enough samples to train such a model, personalized models may be produced.

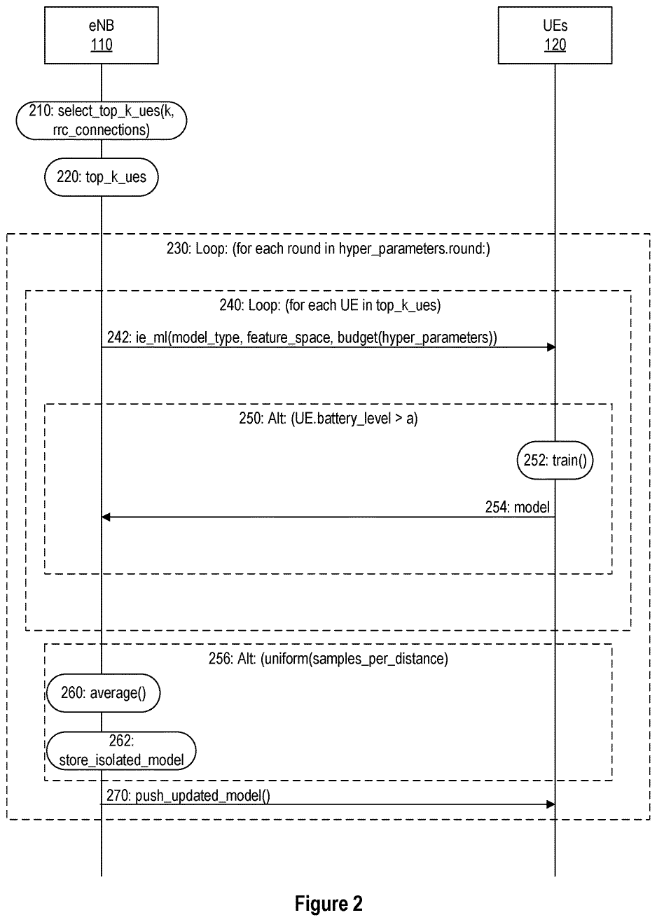

FIG. 2 illustrates an example of a process performed by the eNB 110 of FIG. 1 to adjust power consumption based on a communication device based prediction model(s) generated by UEs 120. The sequence of operations provide an example of how the eNB 110 combines communication device based prediction models trained by each of multiple UEs 120 into a combined communication device based prediction model, and provides the combined communication device based prediction model to each of the UEs. In this example, each UE 120 is assumed to have enough capacity and samples to train a communication device based prediction model (e.g., a machine learning model such as a neural network, etc.). In alternative examples, some UEs may transmit a response message that indicates they are unable to generate and provide a communication device based prediction model.

At operation 210, the eNB 110 determines a set of UEs 120. In some examples, the set of UEs 120 are selected based on historical data from the UEs within a coverage area of the eNB 110 that most frequently connect to the eNB. Operation 220 identifies the determined set of UEs 120. Operation 230 is a loop encompassing operations 240, 242, 250, 252, 254, 256, 260, 262, and 270, which indicates these operations are performed for a predetermined number of rounds determined by the number of UEs 120 identified in operation 220. For each round in operation 230, eNB 110 identifies hyper_parameters for the training at each UE 120. The hyper_paramaters can include, without limitation, different parameters related to the communication device based prediction model to be trained at each UE 120. For example, if the communication device based prediction model is a neural network, hyper_parameters can include, without limitation, the number of layers included in the neural network, an amount of time within which each of the UEs 120 is to train the neural network, etc. In another example, if the communication device based prediction model is a random tree, the hyper_parameters can include, without limitation, a depth of the random tree for each of the identified UEs 120, etc.

Still referring to FIG. 2, operation 240 is a loop encompassing operation 242, which indicates that these operations are performed for each UE identified in operation 240. At operation 242, eNB 110 transmits a message (here, ie_ml) to a specific UE of the identified UEs 120. The message includes a request to train a communication device based prediction model provided by eNB 110, and provide the trained communication device based prediction model to the eNB 110. In this example, the message further includes, the model to be trained (e.g., model type in the example of FIG. 2), and features and parameters related to the model to be trained (e.g., feature_space and budget(hyper_parameters) as illustrated in the example of FIG. 2). The feature_space can indicate features that the eNB 110 wants to learn from the identified UEs 120 and that will be inputs to the communication device based prediction model. The feature_space can indicate a communication feature to be measured and input to the communication device based prediction model. For example, feature_space can indicate that the UE should measure: a location of the UE; a distance of the UE from the eNB; a reference signal received power (“RSRP”); a reference signal received quality (“RSRQ”); an amount of bits per a time unit sent or received by the UE; and/or a signal to noise ratio (“SNR”); and input the communication feature into the communication device based prediction model.

Operation 250 is a loop that includes operations 252 and 254, which indicates these operations are performed as long as the corresponding UE's 120 battery level stays above a threshold level. At operation 252, the UE trains the communication device based prediction model in response to the message received in operation 242. At operation 254, the UE transmits the trained communication device based prediction model to the eNB 110.

Operation 256 is an alternative or additional loop that includes operations 260 and 262, which indicates these operations can also be performed. At operation 260, the eNB 110 averages each of the communication device based prediction models received from the UEs 120 to generate a combined communication device based prediction model. At operation 262, eNB 110 stores the combined communication device based prediction model.

At operation 270, the eNB 110 transmits the updated or combined communication device based prediction model to the UEs 120.

Still referring to FIG. 2, the sequence diagram of FIG. 2 illustrates a federated version of training, which may be optimal in terms of a volume of data that is needed to train each communication device based prediction model. In some embodiments, UEs 120 are selected to join the federation based on their device type. In the downlink communication device based prediction model, the volume of data that is sent/received every time unit (e.g., every hour) are used as features.

In some embodiments, a feature space includes: Feature space=[X=time_window(backwards, 5, hours), holiday, rat_type, Y\hat{ }=time_window(forward, 5, hours)]

Still referring to FIG. 2, in some embodiments, a training process for energy production is provided. For network nodes (e.g., eNB 110), the method includes an energy production model (in other words, a network node based prediction model). In some embodiments, the network node based prediction model is trained in a centralized way using information that is locally stored. Alternatively or additionally, the network node based prediction model is trained in a federated way.

Still referring to FIG. 2, in some embodiments, the training process for the network node based prediction model includes a feature space. The feature space can include, e.g., a time_window of 5 past hours (time_window(5, hours) and a time_window(5, hours) forward for the prediction. Additional features can include, without limitation, weather conditions (e.g., sunny, rainy, cloudy, etc.) and temperature. In some embodiments for eNBs, multiple models for each network node based prediction model, for the grid and also for typical energy consumption of the eNB, may be provided. In some embodiments, if a network node is equipped with more than one energy harvesting methods, the multiple models for the network node can include a different network node based prediction model per energy source.

In some embodiments, regular grid energy consumption (e.g., as opposed to green energy) is counted in kWh in a performance management (pm) counter (e.g., a pm counter named pmConsumedEnergy_sum. In some embodiments, instead of “sum” in the pm counter, the pm counter can include_avg, _mean, _std, etc. since grid energy consumption can be aggregated when the amount of energy consumption is collected periodically (e.g., at 15 minute intervals).

An attach process and/or time series matching is now described.

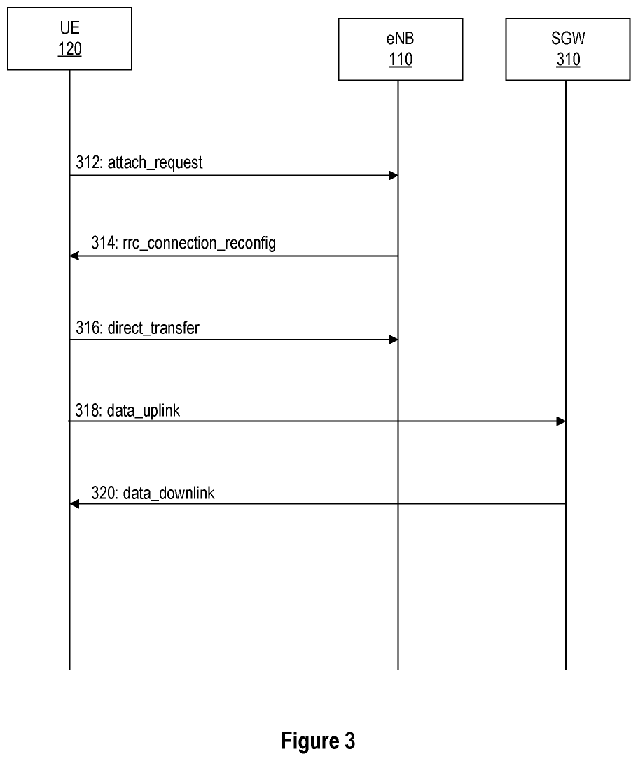

A complete attach process is available at 3GPP TS 24.301 V13.8.0 (2016 September). FIG. 3 is a simplified diagram of sequences from 3GPP TS 24.301 V13.8.0 (2016 September) illustrating a request that is submitted from a UE. FIG. 3 omits other parts such as authentication, mobility management entity (MME) interaction, SGW and packet data network gateway (PGW) selection.

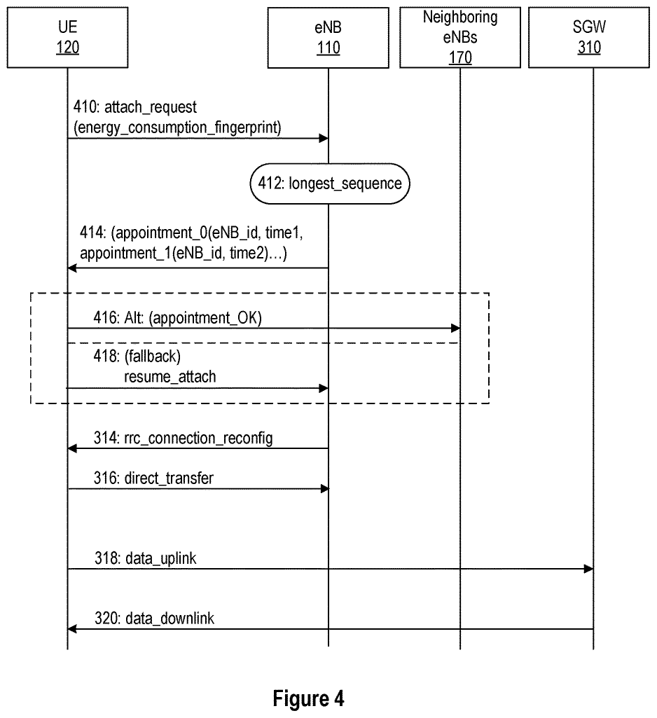

FIG. 4 is a sequence diagram illustrating operations of an attach process in accordance with some embodiments of the present disclosure. The exemplary embodiment of FIG. 4 makes use of a communication device based prediction model (also referred to herein as an energy consumption fingerprint) of UE 120 as input (attach request 410) in order to determine which eNB, and at which point in time the eNB, can serve the majority of uplink/downlink requests that will be made from UE 120. If such an eNB exists, and if the point in time is suitable for UE 120, then the attach process proceeds (operation 416) with that eNB (e.g., an eNB from neighboring eNBs 170). Otherwise, in operation 418, UE 120 fallbacks to current eNB 110.

Still referring to FIG. 4, in some embodiments, time series matching is implemented in operation 412. In some embodiments, the time series matching implemented in operation 412 is an adapted version of a longest common subsequence problem to find a time window in one or more eNBs 110, 170 (e.g., top_k eNBs that have the best signal-to-interference ratio (SINR) with UE 120). In various embodiments of the present disclosure, each item in the sequence (amount of energy needed) does not have to be an exact match but instead can be a partial match that is large enough to accommodate the request.

Input to the longest common sequence operation 412 includes the output of the two predictive models (the communication device based prediction model and the network node based prediction model). The communication device based prediction model forecasts the amount of energy needed for UE 120 (e.g., energy_consumption_fingerprint) and the network node based prediction model predicts an amount of energy that eNB 110 will produce in the next t+n time units (e.g., energy_prediction_fingerprint). Longest sequence operation 412 can find all possible subsequences that match or partially match this requirement. The output of longest common sequence operation 412 includes the time slots and their corresponding length. In this way, UE 120 is presented with two options: (1) to choose the earliest possible time slot (e.g., which can be better for mission critical requests); or (2) to choose the longest match (e.g., which can be better if the transmission can be deferred in time).

An exemplary embodiment of pseudo code for a longest common sequence operation 412 is as follows:

```
  def sufficient(a,b): return b >= 1.5*a # [It is noted that 1.5 is added
  for redundancy
in case the prediction is not accurate enough]
  def lcs(last_time_slot, energy_consumption_footprint,
energy_production_footprint):
    if sufficient(energy_consumption_footprint[last_time_slot],
energy_production_footprint):
      return 1 + lcs(energy_consumption_footprint[last_time_slot-1],
        energy_production_footprint[last_time_slot-1] )
    else:
      return max(lcs(energy_consumption[last_time_slot-1]),
  energy_production_footprint),
          lcs(energy_consumption,
          energy_production_footprint[last_time_slot-1])
  def main( ):
    results = { }
    for eNB in top_k_eNBs:
      1 = results.get(eNB.id, [ ])
      1.append( eNB.id, lcs(t0, ue.energy_consumption_footprint,
  eNB.energy_production_footprint)
      results[enB.id] = 1
    return results
```

In some embodiments, the computational cost of a longest common sequence operation 412 is O(kmn), where k is the number of eNBs 110, 170, m the length of the energy consumption footprint, and n the length of the energy production footprint. Energy consumption footprint and energy production footprint refer to a prediction from the communication device based prediction model and the network node based prediction model, respectively. In some embodiments, as an optimization in order to avoid the cost of recursion, instead memorize the results of location services (LCS) can be memorized and looked up to avoid running the same function again.

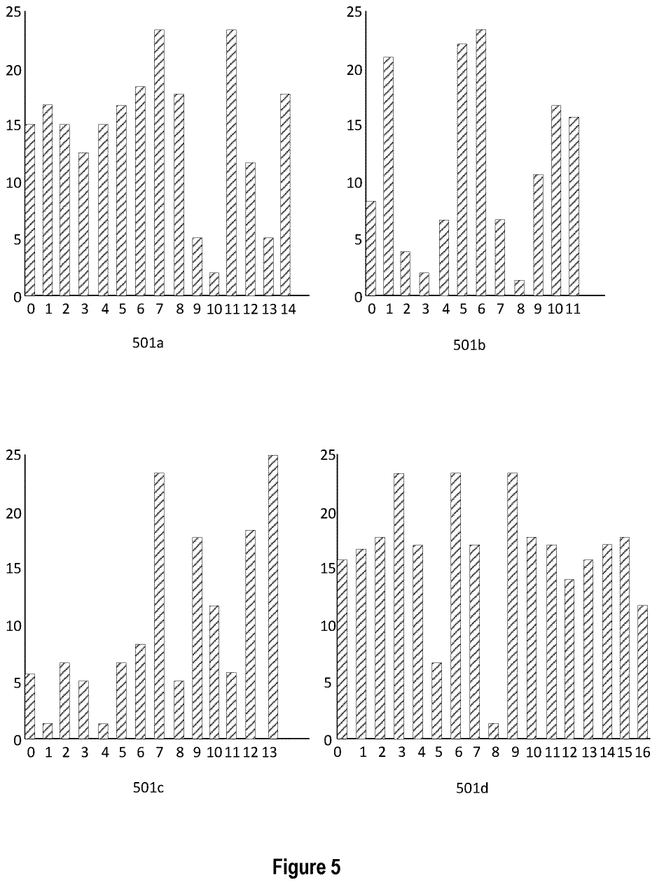

FIG. 5 includes four bar charts 501a-501d illustrating energy harvesting for each of four base stations eNB1-eNB4, respectively (e.g., from eNBs 110, 170), in accordance with some embodiments of the present disclosure. In each of the exemplary bar charts of FIG. 5, the X axis contains time slots and the y axis is the amount of energy that has been harvested. As illustrated in FIG. 5, the first eNB1 (bar chart 501a for eNB1) harvests 15 units of energy at time slot 0, 16 at time slot 2, and so on. Bar charts 501b for eNB2, 501c for eNB3, and 501c for eNB3 similarly illustrate an amount of energy units harvested by each eNB at each illustrated time slot. In the exemplary embodiment of FIG. 5, eNB1 (bar chart 501a) and eNB4 (bar chart 501d) are candidate eNBs for UE 120 to attach on given the SINR between UE 120 and these eNBs. A regular process for measuring SINR and negotiating between eNBs using CSI tables can be applied as mandated by 3GPP TS 24.301 V13.8.0 (2016 September).

FIG. 6 is a bar chart illustrating expected energy needed to handle data transmission of UE 120 at different time slots in accordance with some embodiments of the present disclosure. The X axis of FIG. 6 contains time slots and the y axis is the amount of expected energy needed.

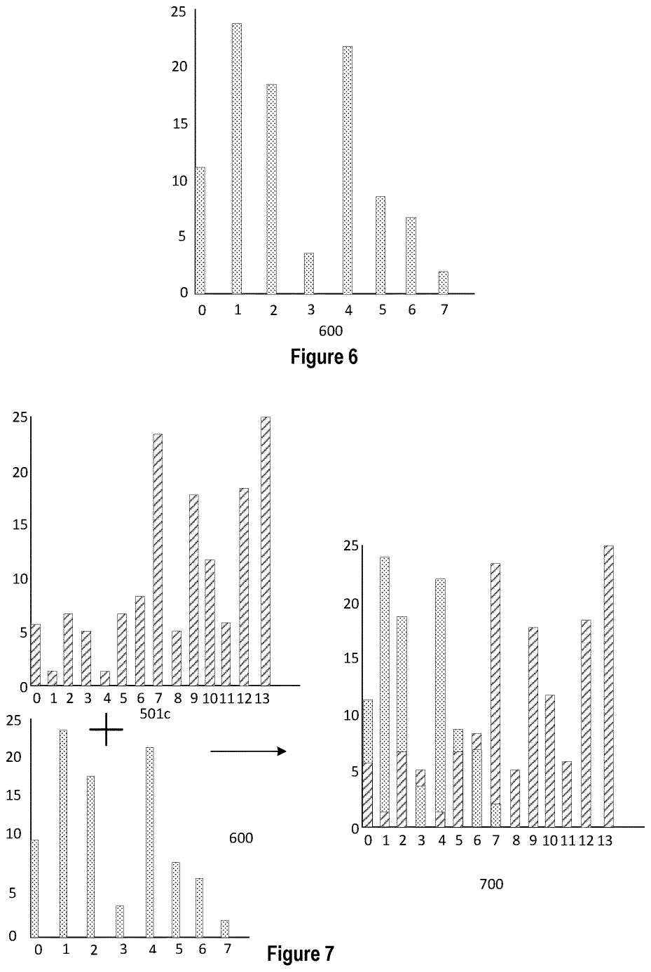

FIG. 7 includes an overlay bar chart 700 illustrating a visual comparison of expected energy use from FIG. 6 with harvested energy from eNB3 (bar chart 501c) of FIG. 5 in accordance with some embodiments of the present disclosure.

Overlay bar chart 700 visually illustrates a comparison of expected energy use of UE 120 in time slots 0-7 (shown with dotted pattern in the bars for time slots 0-7) with the harvested energy of eNB3 of bar chart 501c (shown with diagonal line pattern in the bars for time slots 0-7). Referring to overlay bar chart in FIG. 7, the following is shown for time slots 0-7:
Time slot 0 (“t0”)=false (because it is not enough since at t0, eNB=5 but UE needs 11)
Time slot 1 (“t1”)=false (because it is not enough since at t1, eNB=1 but UE needs 24)
Time slot 2 (“t2”)=false (because it is not enough since at t2, eNB 6 but UE needs 19)
Time slot 3 (“t3”)=true (since at t3, UE needs 4 and eNB has 4)
Time slot 4 (“t4”)=false (because it is not enough since at t4, UE needs 23 and eNB has 1)
Time slot 5 (“t5”)=false (because it is not enough since at t5, UE needs 9 and eNB has 6)
Time slot 6 (“t6”)=true (since at t6, UE needs 6 and eNB has 9)
Time slot 7 (“t7”)=true (since at t7, UE needs 1 and eNB has 23)

In an exemplary embodiment, applying longest common sequence operation 412 to all four eNB histogram bar charts shown in FIG. 5, produces the following results indicating the different time slots that match or do not match the expectation of UE 120 in terms of needed energy. Additionally, since different possibilities can be examined, in the matrix below, UE 102's expectation is also shifted at different points in time. All results below follow the same format (shown with headers above row 0 in the exemplary results below): first, the time shift is identified; followed by an array of true and false values identifying whether a certain time slot has a match or not; and then the total number of matches is identified. Underneath some of the more interesting results, a sentence is provided explaining the finding. Top consecutive green slots are indicated with underlined font.

In an exemplary embodiment, a first set of results is shown for LCS with eNB1 by deferring UE 120's transmission (from 0 to 6 points in time):
Time_Shift [t0, t1, t2, t3, t4, t5, t6, t7.] total number_matching_time_slots
0 [True, False, False, True, False, True, True, True] 5
   In row 0, UE 120's histogram is not shifted. Thus, a case when the UE needs to transmit data immediately is examined. In this exemplary embodiment, five time slots match, but the longest common path occurs at time slot 5 (t5).
1 [True, False, False, True, False, True, True, True] 5
   In row 1, UE 120's transmission is shifted at one point in time and there are five matching time slots, with the longest occurring at time slot 5 (t5) as before.
2 [True, False, False, True, False, True, True, True] 5
   In row 2, UE 120's transmission is shifted at two points in time and there are five matching slots, with the longest occurring at time slot 3 (t3). Thus, if this time shift is chosen for this eNB, a consecutive “green pocket” can be utilized earlier than in the previous findings but only if UE 120 waits to transmit. This time shift is a candidate solution for a non-critical transmission.
3 [True, False, False, True, True, True, False, True] 5
4 [True, False, False, True, False, False, False, True] 3
   In row 4, there are only three matching time slots if UE 120 waits for four time units.
[True, False, True, True, False, False, True, True] 5
6 [True, True, False, True, False, True, True, True] 6
   Row 6 has the highest number of matching slots so far (six), but UE 120 needs to wait for six time units.

In another exemplary embodiment, results are shown for a second LCS with eNB2 by deferring UE 120's transmission (from 0 to 3 points):
0 [False, False, False, False, False, True, True, True] 3
1 [True, False, False, True, False, True, False, True] 4
2 [False, False, False, True, True, False, False, True] 3
3 [False, False, True, True, False, False, True, True] 4
   For eNB2, there is a low count of matches with the best one occurring if UE 120 waits for 1 or 3 time units. A highest consecutive match occurs if UE 120 does not wait (row 0) at time slot 5.

In another exemplary embodiment, results are shown for a third LCS with eNB3 by deferring UE 120's transmission (from 0 to 5 points):
0 [False, False, False, True, False, False, True, True] 5
1 [False, False, False, False, False, True, True, True] 3
2 [False, False, False, True, False, True, False, True] 3
3 [False, False, False, True, True, False, True, True] 4
4 [False, False, False, True, False, True, True, True] 4
5 [False, False, True, True, False, True, False, True] 4
   For eNB3, the highest match occurs if there is no shift (i.e., start transmitting immediately). However, the highest consecutive match of green time slots only happens if UE 120 defers transmission for 1 time unit or 4 time units.

In another exemplary embodiment, results are shown for a fourth LCS with eNB4 by deferring UE 120's transmission (from 0 to 8 points):
0 [True, False, False, True, False, False, True, True] 4
1 [True, False, True, True, False, True, True, True]6
2 [True, True, False, True, True, True, False, True]6
3 [True, False, False, True, False, False, True, True] 4
4 [True, False, True, True, False, True, True, True]6
5 [False, True, False, False, True, True, True, True] 5
6 [True, False, False, True, False, True, True, True] 5
7 [True, False, True, True, False, True, True, True]6
8 [False, True, False, True, False, True, True, True] 5
   For eNB4, multiple consecutive green slots and high matches occur, particularly if UE 120 waits for 1 time slot.

In an exemplary embodiment, as illustrated in the above results, using a longest common sequence operation has an overall best match of eNB_1 if a decision is made to allocate (e.g., schedule) resources immediately for UE 120 (timeslot 0). However, if UE 120 can defer scheduling the resource allocation for 1 time slot, then the best match is eNB4.

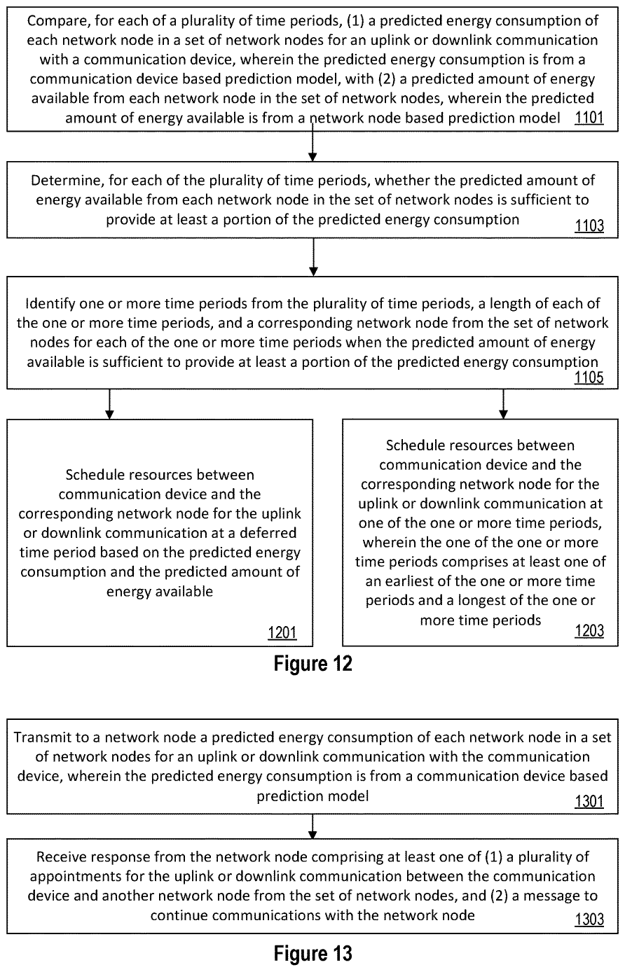

Now that the operations of the various components have been described, operations specific to a network node 900 (implemented using the structure of the block diagram of FIG. 9) for performing a method for a telecommunications network will now be discussed with reference to the flow charts of FIGS. 11 and 12 according to various embodiments of the present disclosure. As shown, network node 900 may include network interface circuitry 907 (also referred to as a network interface) configured to provide communications with other nodes of the network, communication devices, and/or the radio access network RAN. Network node 900 may also include a processing circuitry 903 (also referred to as a processor) coupled to the network interface circuitry, and memory circuitry 905 (also referred to as memory) coupled to the processing circuitry 903. The memory circuitry 905 may include computer readable program code that when executed by the processing circuitry 903 causes the processing circuitry 903 to perform operations. Further, modules may be stored in memory 905, and these modules may provide instructions so that when the instructions of a module are executed by respective computer processing circuitry of processor 903, processing circuitry of processor 903 performs respective operations of the flow charts of FIGS. 11 and 12 according to embodiments disclosed herein.

Each of the operations described in FIGS. 11 and 12 can be combined and/or omitted in any combination with each other, and it is contemplated that all such combinations fall within the spirit and scope of this disclosure.

Referring to FIGS. 11 and 12, a method performed by a network node for a telecommunications network is provided. The method includes comparing (1101), for each of a plurality of time periods, (1) a predicted energy consumption of each network node in a set of network nodes for an uplink or downlink communication with a communication device, wherein the predicted energy consumption is from a communication device based prediction model, with (2) a predicted amount of energy available from each network node in the set of network nodes, wherein the predicted amount of energy available is from a network node based prediction model. The method further includes determining (1103), for each of the plurality of time periods, whether the predicted amount of energy available from each network node in the set of network nodes is sufficient to provide at least a portion of the predicted energy consumption. The method further includes identifying (1105) one or more time periods from the plurality of time periods, a length of each of the one or more time periods, and a corresponding network node from the set of network nodes for each of the one or more time periods when the predicted amount of energy available is sufficient to provide at least a portion of the predicted energy consumption.

In some embodiments, the method further includes scheduling (1201) resources between the communication device and the corresponding network node for the uplink or downlink communication at a deferred time period based on the predicted energy consumption and the predicted amount of energy available.

In some embodiments, the scheduling (1201) resources includes scheduling at the deferred time period to maximize a use of an amount of renewable energy for the predicted energy consumption.

In some embodiments, the method further includes scheduling (1203) resources between the communication device and the corresponding network node for the uplink or downlink communication at one of the one or more time periods, wherein the one of the one or more time periods comprises at least one of an earliest of the one or more time periods and a longest of the one or more time periods.

In some embodiments, the resources include at least one of: a remote electrical tilt for an antenna at the corresponding network node, a cell, a wide beam, a narrow beam, or a carrier allocated to the communication device for the communication device to begin the uplink or the downlink communication, a transfer of traffic of the communication device, or a handover of the communication device from a first cell to a second cell.

In some embodiments, the predicted energy consumption is an output from the communication device based prediction model and the predicted amount of energy available is an output from the network node based prediction model.

In some embodiments, the communication based prediction model includes at least one of a machine learning model or a federated machine learning model and the network node based prediction model includes at least one of a machine learning model or a federated machine learning model.

In some embodiments, the determining (1103) includes a time series matching based on a complete match or a partial match to identify the one or more time periods when the predicted amount of energy available from the corresponding network node is sufficient to provide at least a portion of the predicted energy consumption.

Various operations from the flow chart of FIG. 12 may be optional with respect to some embodiments of a method performed by a network node for a telecommunications network, and related methods. For example, operations of blocks 1201 and 1203 of FIG. 12 may be optional.

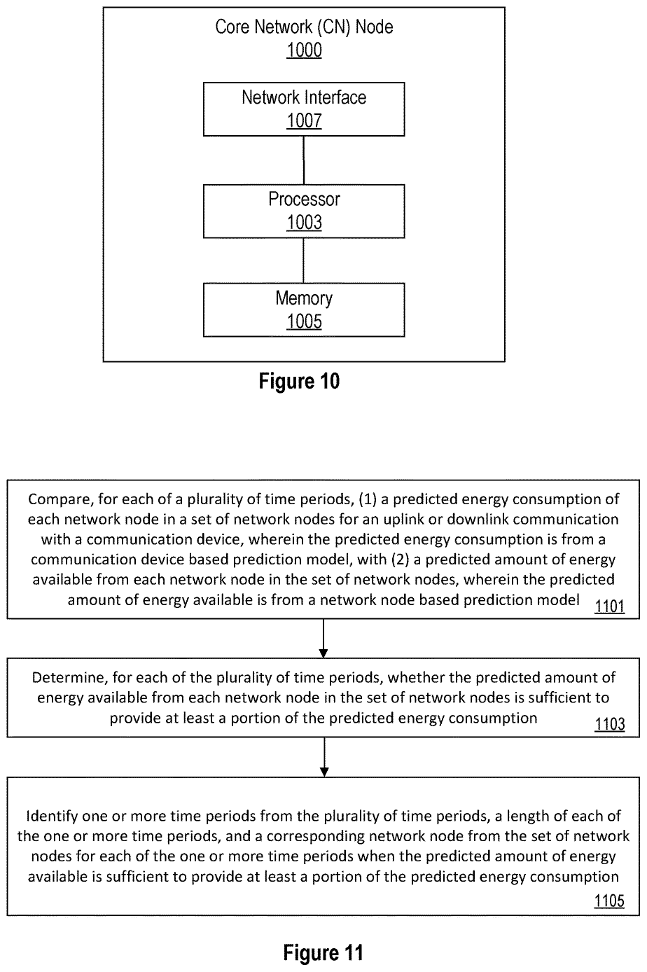

FIG. 10 is a block diagram illustrating elements of a core network CN node (e.g., an SGW node, etc.) of a telecommunications network configured to provide cellular communication according to embodiments of the present disclosure. As shown, the CN node may include network interface circuitry 1007 (also referred to as a network interface) configured to provide communications with other nodes of the core network and/or the radio access network RAN. The CN node may also include a processing circuitry 1003 (also referred to as a processor) coupled to the network interface circuitry, and memory circuitry 1005 (also referred to as memory) coupled to the processing circuitry. The memory circuitry 1005 may include computer readable program code that when executed by the processing circuitry 1003 causes the processing circuitry to perform operations according to embodiments disclosed herein. According to other embodiments, processing circuitry 1003 may be defined to include memory so that a separate memory circuitry is not required.

As discussed herein, operations of the CN node may be performed by processing circuitry 1003 and/or network interface circuitry 1007. For example, processing circuitry 1003 may control network interface circuitry 1007 to transmit communications through network interface circuitry 1007 to one or more other network nodes and/or to receive communications through network interface circuitry from one or more other network nodes. Moreover, modules may be stored in memory 1005, and these modules may provide instructions so that when instructions of a module are executed by processing circuitry 1003, processing circuitry 1003 performs respective operations (e.g., operations discussed herein with respect to example embodiments relating to core network nodes).

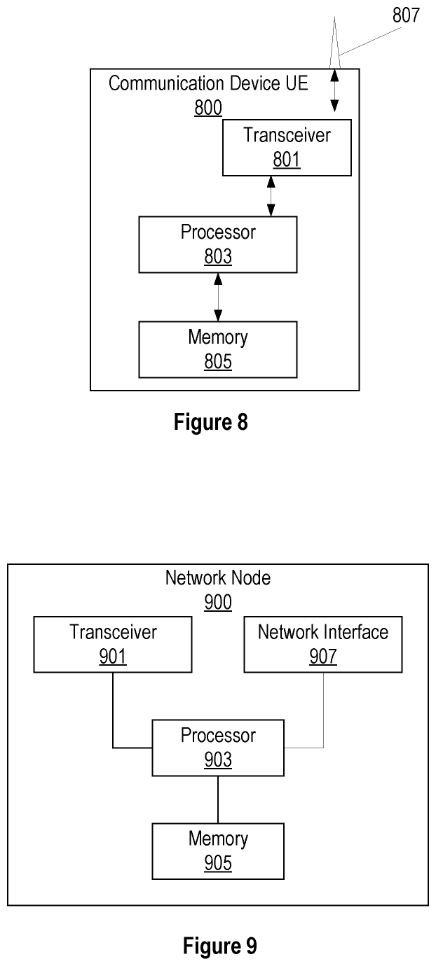

Operations specific to a communication device 800 (implemented using the structure of the block diagram of FIG. 8) for performing a method for a telecommunications network will now be discussed with reference to the flow chart of FIG. 13 according to various embodiments of the present disclosure. Communication device 800 can include, without limitation, a user equipment (UE), a wireless terminal, a wireless communication device, a wireless communication terminal, a terminal node/device, etc. As shown, communication device 800 includes a transceiver 801 comprising one or more power amplifiers that transmit and receive through antennas of an antenna 807 to provide uplink and downlink radio communications with a radio network node (e.g., a base station, eNB, gNB, etc.) of a telecommunications network. Instead of or in addition to the transceiver 801, the communication device 800 may include a light reception front-end configured to receive light signaling such from a Light WiFi AP. Communication device 800 further includes a processor circuit 803 (also referred to as a processor) coupled to the transceiver 801 and a memory circuit 805 (also referred to as memory). The memory 805 stores computer readable program code that when executed by the processor 803 causes the processor 803 to perform operations according to embodiments disclosed herein.

Referring to FIG. 13, a method performed by a communication device in a telecommunications network is provided. The method includes transmitting (1301) to a network node a predicted energy consumption of each network node in a set of network nodes for an uplink or downlink communication with the communication device. The predicted energy consumption is from a communication device based prediction model. The method further includes, responsive to the transmitting, receiving (1303) a response from the network node including at least one (1) a plurality of appointments between the communication device and another network node from the set of network nodes, wherein the plurality of appointments include an appointment for the uplink or downlink communication for the communication device with another network node from the set of network nodes, and (2) a message to continue communications with the network node. Thus, the response can include an appointment for the uplink or downlink communication for the communication device with another network node from the set of network nodes. Otherwise if none of the appointments satisfy the predicted energy consumption, the response includes a message to continue communications with the current network node (in other words, fallback to the current network node).

In some embodiments, the plurality of appointments include a plurality of time periods having a length based at least in part on the predicted energy consumption and a predicted amount of energy available, and wherein the appointment for the uplink or downlink communication for the communication device with another network node comprises an appointment at a deferred time period to maximize use of an amount of renewable energy for the predicted energy consumption.

In some embodiments, the plurality of appointments include an appointment for the uplink or downlink communication for the communication device with another network node from the set of network nodes for each of a plurality of time periods having a length. The plurality of time periods include at least one of an earliest of the plurality of time periods and a longest of the plurality of time periods.

In some embodiments, the plurality of appointments are determined based on a time series matching based on a complete match or a partial match to identify the plurality of time periods when the predicted amount of energy available from the another network node from the set of network nodes is sufficient to provide at least a portion of the predicted energy consumption.

In some embodiments, the communication device based prediction model comprises at least one of a machine learning model or a federated machine learning model.

In the above description of various embodiments of the present disclosure, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the examples of embodiments and their equivalents, and shall not be restricted or limited by the foregoing detailed description.

1. A method performed by a network node for a telecommunications network, the method comprising:
comparing, for each of a plurality of time periods, (1) a predicted energy consumption of each network node in a set of network nodes for an uplink or downlink communication with a communication device, wherein the predicted energy consumption is from a communication device based prediction model, with (2) a predicted amount of energy available from each network node in the set of network nodes, wherein the predicted amount of energy available is from a network node based prediction model;
determining, for each of the plurality of time periods, whether the predicted amount of energy available from each network node in the set of network nodes is sufficient to provide at least a portion of the predicted energy consumption; and
identifying one or more time periods from the plurality of time periods, a length of each of the one or more time periods, and a corresponding network node from the set of network nodes for each of the one or more time periods when the predicted amount of energy available is sufficient to provide at least a portion of the predicted energy consumption.

2. The method of claim 1, further comprising:
scheduling resources between the communication device and the corresponding network node for the uplink or downlink communication at a deferred time period based on the predicted energy consumption and the predicted amount of energy available.

3. The method of claim 2, wherein the scheduling resources comprises scheduling at the deferred time period to maximize a use of an amount of renewable energy for the predicted energy consumption.

4. The method of claim 1, further comprising:
scheduling resources between the communication device and the corresponding network node for the uplink or downlink communication at one of the one or more time periods, wherein the one of the one or more time periods comprises at least one of an earliest of the one or more time periods and a longest of the one or more time periods.

5. The method of claim 2, wherein the resources comprises at least one of:
a remote electrical tilt for an antenna at the corresponding network node,
a cell, a wide beam, a narrow beam, or a carrier allocated to the communication device for the communication device to begin the uplink or the downlink communication,
a transfer of traffic of the communication device, or
a handover of the communication device from a first cell to a second cell.

6. The method of claim 1, wherein the predicted energy consumption is an output from the communication device based prediction model and wherein the predicted amount of energy available is an output from the network node based prediction model.

7. The method of claim 1, wherein the communication based prediction model comprises at least one of a machine learning model or a federated machine learning model and wherein the network node based prediction model comprises at least one of a machine learning model or a federated machine learning model.

8. The method of claim 1, wherein the determining comprises a time series matching based on a complete match or a partial match to identify the one or more time periods when the predicted amount of energy available from the corresponding network node is sufficient to provide at least a portion of the predicted energy consumption.

9. A network node for a telecommunications network, the network node comprising:
processing circuitry; and
memory coupled with the processing circuitry, wherein the memory includes instructions that when executed by the processing circuitry causes the network node to perform operations, the operations comprising:
compare, for each of a plurality of time periods, (1) a predicted energy consumption of each network node in a set of network nodes for an uplink or downlink communication with a communication device, wherein the predicted energy consumption is from a communication device based prediction model, with (2) a predicted amount of energy available from each network node in the set of network nodes, wherein the predicted amount of energy available is from a network node based prediction model;
determine, for each of the plurality of time periods, whether the predicted amount of energy available from each network node in the set of network nodes is sufficient to provide at least a portion of the predicted energy consumption; and
identify one or more time periods from the plurality of time periods, a length of each of the one or more time periods, and a corresponding network node from the set of network nodes for each of the one or more time periods when the predicted amount of energy available is sufficient to provide at least a portion of the predicted energy consumption.

10. The network node of claim 9, wherein the memory includes instructions that when executed by the processing circuitry causes the network node to schedule resources between the communication device and the corresponding network node for the uplink or downlink communication at a deferred time period based on the predicted energy consumption and the predicted amount of energy available.

11-16. (canceled)

17. A method performed by a communication device in a telecommunication network, the method comprising:
transmitting to a network node a predicted energy consumption of each network node in a set of network nodes for an uplink or downlink communication with the communication device, wherein the predicted energy consumption is from a communication device based prediction model; and
responsive to the transmitting, receiving a response from the network node comprising at least one of (1) a plurality of appointments between the communication device and another network node from the set of network nodes, wherein the plurality of appointments comprise an appointment for the uplink or downlink communication for the communication device with another network node from the set of network nodes, and (2) a message to continue communications with the network node.

18. The method of claim 17, wherein the plurality of appointments comprise a plurality of time periods having a length based at least in part on the predicted energy consumption and a predicted amount of energy available, and wherein the appointment for the uplink or downlink communication for the communication device with another network node comprises an appointment at a deferred time period to maximize use of an amount of renewable energy for the predicted energy consumption.

19. The method of claim 17, wherein the plurality of appointments comprise an appointment for the uplink or downlink communication for the communication device with another network node from the set of network nodes for each of a plurality of time periods having a length, wherein the plurality of time periods comprise at least one of an earliest of the plurality of time periods and a longest of the plurality of time periods.

20. The method of claim 17, wherein the plurality of appointments are determined based on a time series matching based on a complete match or a partial match to identify the plurality of time periods when the predicted amount of energy available from the another network node from the set of network nodes is sufficient to provide at least a portion of the predicted energy consumption.

21. The method of claim 17, wherein the communication device based prediction model comprises at least one of a machine learning model or a federated machine learning model.

22. A communication device in a telecommunications network, the communication device comprising:
processing circuitry; and
memory coupled with the processing circuitry, wherein the memory includes instructions that when executed by the processing circuitry causes the communication device to perform operations, the operations comprising:
transmit to a network node a predicted energy consumption of each network node in a set of network nodes for an uplink or downlink communication with the communication device, wherein the predicted energy consumption is from a communication device based prediction model; and
receive a response from the network node comprising at least one of (1) a plurality of appointments between the communication device and another network node from the set of network nodes, wherein the plurality of appointments comprise an appointment for the uplink or downlink communication for the communication device with another network node from the set of network nodes, and (2) a message to continue communications with the network node.

23. The communication device of claim 22, wherein the plurality of appointments comprise a plurality of time periods having a length based at least in part on the predicted energy consumption and a predicted amount of energy available, and wherein the appointment for the uplink or downlink communication for the communication device with another network node comprises an appointment at a deferred time period to maximize use of an amount of renewable energy for the predicted energy consumption.

24.-28. (canceled)

29. The network node of claim 9, wherein the memory includes instructions that when executed by the processing circuitry causes the network node to scheduling resources between the communication device and the corresponding network node for the uplink or downlink communication at one of the one or more time periods, wherein the one of the one or more time periods comprises at least one of an earliest of the one or more time periods and a longest of the one or more time periods.

30. The network node of claim 9, wherein the predicted energy consumption is an output from the communication device based prediction model and wherein the predicted amount of energy available is an output from the network node based prediction model.

31. The communication device of claim 22, wherein the plurality of appointments comprise an appointment for the uplink or downlink communication for the communication device with another network node from the set of network nodes for each of a plurality of time periods having a length, wherein the plurality of time periods comprise at least one of an earliest of the plurality of time periods and a longest of the plurality of time periods.
